(19) United States
(12) Patent Application Publication
(10) Pub. No.: US 2017/0195979 A1
(43) Pub. Date: Jul. 6, 2017

(54) TERMINAL APPARATUS

(71) Applicant: Sharp Kabushiki Kaisha, Sakai City, Osaka (JP)

(72) Inventors: Osamu NAKAMURA, Sakai City (JP); Jungo GOTO, Sakai City (JP); Hiromichi TOMEBA, Sakai City (JP); Shiro WAKAHARA, Sakai City (JP); Yasuhiro HAMAGUCHI, Sakai City (JP)

(21) Appl. No.: 15/318,682

(22) PCT Filed: Jun. 10, 2015
(86) PCT No.: PCT/JP2015/066718

§ 371 Date: Dec. 14, 2016

(30) Foreign Application Priority Data
Jun. 19, 2014 (JP) 2014-125991

(51) Int. Cl. H04W 52/36; H04W 72/04

(52) U.S. Cl. CPC H04W 52/367; H04W 72/0473

(57) ABSTRACT

Optimal transmit power control is performed in a band other than licensed bands. When the way of specifying transmit power differs between the licensed band and a frequency band other than the licensed band, the expression of the transmit power control is changed to perform transmit power control. A terminal apparatus includes a carrier aggregation radio transmission unit configured to simultaneously transmit a plurality of component carriers, and a transmit power control unit configured to control transmit power of each of the plurality of component carriers, wherein the transmit power control unit calculates a transmit power of a dedicatedly usable first component carrier among the plurality of component carriers in consideration of the transmit power of the first component carrier, and calculates a transmit power of a second component carrier other than the dedicatedly usable first component carrier in consideration of the transmit power of the first component carrier.

### TECHNICAL FIELD

The present invention relates to a terminal apparatus.

### BACKGROUND ART

The Long Term Evolution (LTE) system, which is a 3.9th-generation wireless communication system for mobile phones, has been standardized. As one of fourth-generation wireless communication systems, an LTE-A (also referred to as LTE-Advanced) system as a further advanced system of the LTE system is now being standardized.

In an uplink (communication from a terminal apparatus to a base station apparatus, also referred to as a reverse link) of a cellular communication system including the LTE system, required transmit power varies depending on the distance between the terminal apparatus and the base station apparatus. To reduce power consumption of the terminal apparatus, Transmit Power Control (TPC) is adopted to perform transmission with minimum power required to satisfy a prescribed reception quality (hereinafter referred to as required transmit power). The TPC also provides the advantage that interference with a base station apparatus which is not performing communication is mitigated. The TPC in the LTE system is specified by a specification (NPL 1).

NPL 1 specifies that a terminal apparatus in the LTE system is configured to report a power headroom (PH) to a base station apparatus. The PH represents a value obtained by subtracting transmit power [dBm] required to achieve desired receive power of the base station apparatus from the maximum transmit power [dBm] of the terminal apparatus. When the PH is positive, it is reported to the base station apparatus that the terminal apparatus has surplus transmit power, whereas when the PH is negative, it is reported to the base station apparatus that the transmit apparatus has no surplus transmit power and the transmit apparatus is forced to perform transmission with its maximum transmit power. The base station apparatus performs closed loop TPC based on the reported PH, actual receive power, and other parameters, and/or uses the reported PH for subsequent scheduling, and the like (for example, to determine a bandwidth to be assigned to the terminal apparatus), thereby enabling optimal control.

The LTE-A system (LTE Rel. 10 or later releases) also uses a Carrier Aggregation (CA) technique in which one system band of the LTE system is defined as a Component Carrier (CC, also referred to as a serving cell) and a plurality of CCs are simultaneously used. When the CA is performed, one CC is used as a Primary Cell (PCell) capable of realizing all functions including reporting control information, and the other CCs are used as Secondary Cells (SCells) mainly for transmission/reception of data. NPL 1 also specifies TPC in a case of the CA being performed.

Securing frequency resources is an important issue for the LTE system to support a steep increase in data traffic. Frequency bands to which the LTE system has been directed are so-called licensed bands licensed by a country or a region in which wireless communication operators provide their service, and therefore, available frequency bands have been limited.

A subject of recent discussion is to provide an LTE system using frequency bands which requires no license from a country or a region and which are so-called unlicensed bands (see NPL 2). The LTE-A system is expected to support the steep increase in data traffic by applying the CA technique used in the LTE-A system to the unlicensed bands.

The cellular communication will use not only unlicensed bands but also frequency bands called white spaces which are not actually used to avoid interference between frequencies (for example, frequency bands assigned to television broadcasting but not used in some regions), common frequency bands which have been exclusively assigned to specific operators and are expected to be shared between a plurality of operators in the future, and other bands.

### CITATION LIST

### Non Patent Literature

NPL 1: 3GPP TS36.213 V11.3.0, “Physical layer procedure,” June 2013.

NPL 2: RP-140259, “Study on Licensed-Assisted Access using LTE,” 3GPP TSG RAN Meeting #63, March 2014.

### SUMMARY OF INVENTION

### Technical Problem

However, since frequency bands, such as unlicensed bands and white spaces, other than licensed bands have different specifications in terms of transmit power depending on countries and/or regions, there may be a case where TPC similar to that performed on the licensed bands cannot be performed on the frequency bands other than the licensed bands. Therefore, TPC based on a specification set forth in each frequency band has to be performed.

In view of the above problems, it is an object of the present invention to provide a method for controlling transmit power in a case of using a frequency band other than licensed bands.

### Solution to Problem

To solve the problems described above, a terminal apparatus according to the present invention has the following configurations.

(1) That is, a terminal apparatus of the present invention includes a carrier aggregation radio transmission unit configured to simultaneously transmit a plurality of component carriers, and a transmit power control unit configured to control transmit power of each of the plurality of component carriers, wherein the transmit power control unit calculates a transmit power of a dedicatedly usable first component carrier among the plurality of component carriers in consideration of the transmit power of the first component carrier, and calculates a transmit power of a second component carrier other than the dedicatedly usable first component carrier in consideration of the transmit power of the first component carrier.

Such a terminal apparatus enables optimal use of transmit power, and thereby the power consumption of the terminal apparatus can be reduced.

(2) In the terminal apparatus of the present invention, the transmit power control unit controls the transmit power of the second component carrier to be less than or equal to a value obtained by subtracting the transmit power of the first component carrier from allowable maximum transmit power of the terminal apparatus.

Such a terminal apparatus enables optimal use of transmit power, and thereby the power consumption of the terminal apparatus can be reduced.

(3) In the terminal apparatus of the present invention, the transmit power control unit calculates the transmit power of the second component carrier in consideration of a power spectral density per frequency.

Such a terminal apparatus enables optimal use of transmit power, and thereby the power consumption of the terminal apparatus can be reduced.

(4) The terminal apparatus of the present invention further includes a carrier aggregation radio transmission unit configured to simultaneously transmit a plurality of component carriers including at least a dedicatedly usable first component carrier and a second component carrier other than the dedicatedly usable first component carrier, and a transmit power control unit configured to control transmit power of each of the plurality of component carriers, wherein the transmit power control unit calculates a transmit power of the second component carrier in consideration of the transmit power of the second component carrier in a case of transmitting a control signal on the second component carrier, and calculates a transmit power of the first component carrier in consideration of the transmit power of the second component carrier.

Such a terminal apparatus enables optimal use of transmit power, and thereby the power consumption of the terminal apparatus can be reduced or a system throughput can be increased.

### Advantageous Effects of Invention

The present invention enables optimal transmit power control in a frequency band other than licensed bands, and thereby the power consumption of the terminal apparatus can be reduced. Interference with a neighbor cell can also be mitigated, thereby increasing the throughput of a system.

### BRIEF DESCRIPTION OF DRAWINGS

FIG. 1 is a view illustrating an example of a communication system.

FIG. 2 is a view schematically illustrating the configuration of a transmitter according to a first embodiment.

FIG. 3 is a view schematically illustrating the configuration of a transmitter according to a second embodiment.

FIG. 4 is a view schematically illustrating the configuration of a transmitter according to a third embodiment.

### DESCRIPTION OF EMBODIMENTS

### First Embodiment

A communication system of the present embodiment includes a base station apparatus (transmitter, cell, transmission point, transmit antenna group, transmit antenna port group, component carrier, or evolved Node B (eNB)) and a terminal apparatus (terminal, mobile terminal, reception point, receiving terminal, receiver, receive antenna group, receive antenna port group, or User Equipment (UE)). The present embodiment describes an unlicensed band as an example of a frequency band other than licensed bands, but the present invention is not limited to the present embodiment.

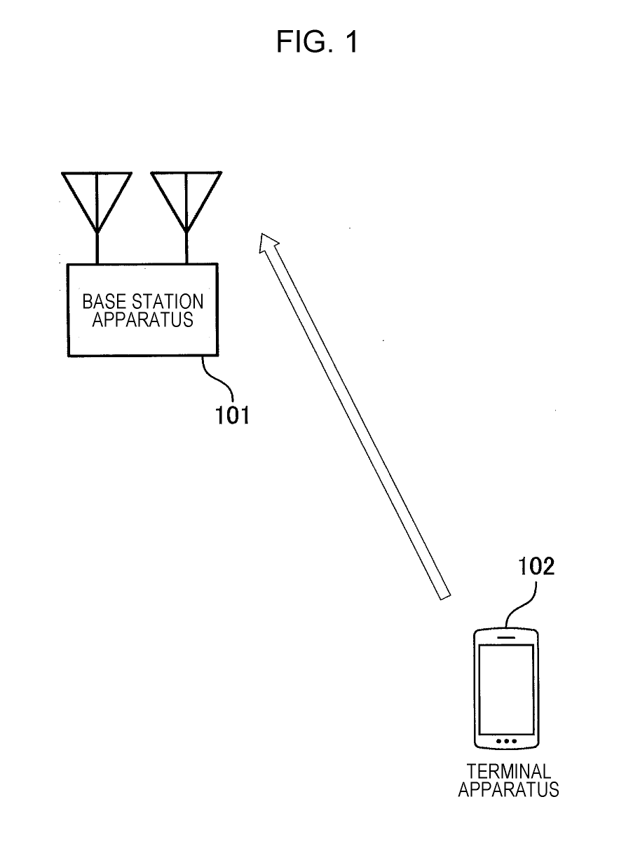

FIG. 1 is a view schematically illustrating an example of an uplink (reverse link) of a cellular system according to the first embodiment of the present invention. The cellular system of FIG. 1 includes a base station apparatus (eNB) 101 and a terminal apparatus 102 which is to be connected to the base station apparatus 101. The base station apparatus 101 and the terminal apparatus 102 communicate with each other using a licensed band and an unlicensed band. Here, the unlicensed band denotes a frequency band on which communication operators can provide their services without a license issued by a country or a region. That is, the unlicensed band is a frequency band which is not dedicatedly usable by a specific communication operator.

The terminal apparatus 102 configures one of component carriers to perform communication with the base station apparatus 101 as a Primary cell (PCell). The frequency band of the PCell is assumed to be, but is not limited to, the licensed band. The PCell may be a component carrier of the unlicensed band. Here, the licensed band denotes a frequency band for which a communication operator obtained a license issued by a country or a region in which the communication operator is to provide its service. That is, the licensed band is a frequency band dedicatedly usable by a specific communication operator.

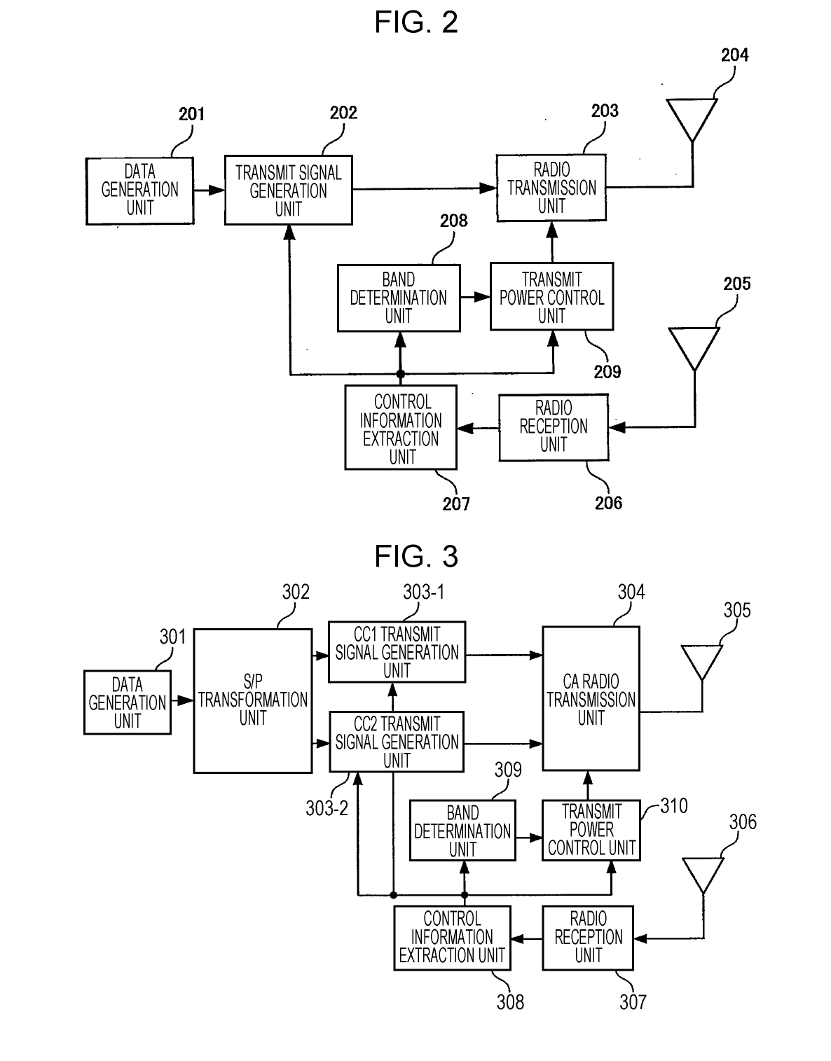

FIG. 2 is a block diagram illustrating a configuration example of the terminal apparatus 102 according to the first embodiment of the present invention. As illustrated in FIG. 2, the terminal apparatus 102 includes a data generation unit 201, a transmit signal generation unit 202, a radio transmission unit 203, a transmit antenna 204, a receive antenna 205, a radio reception unit 206, a control information extraction unit 207, a band determination unit 208, and a transmit power control unit 209.

The data generation unit 201 generates information data (information bit sequences of sound, images, etc.), control information data, a reference signal, and the like which are to be transmitted by the terminal apparatus 102 to the base station apparatus 101. An output of the data generation unit 201 is input to the transmit signal generation unit 202. When the transmit signal generation unit 202 receives the information data from the data generation unit 201, the transmit signal generation unit 202 performs error correction coding and modulation on the information data to obtain a modulation symbol based on control information input from the control information extraction unit 207 and converts the modulation symbol into a frequency domain signal, and then arranges the frequency domain signal on a prescribed frequency subcarrier, and converts the time domain signal into a time domain signal. Thereafter, the transmit signal generation unit 202 adds a cyclic prefix (CP) to the time domain signal, thereby generating a transmit signal. When the transmit signal generation unit 202 receives the control information data, the transmit signal generation unit 202 performs error correction coding (or spreading with a spread code) on the control information data, and then converts the control information data into a modulation symbol. Thereafter, the transmit signal generation unit 202 arranges the modulation symbol on a prescribed frequency subcarrier, converts a time domain signal into a time domain signal, and adds a cyclic prefix (CP) to the time domain signal, thereby generating a transmit signal. An output of the transmit signal generation unit 202 is input to the transmit signal generation unit 203. The radio transmission unit 203 performs Digital to Analog (D/A) conversion and band limiting filtering, and a power amplifier included in the radio transmission unit 203 amplifies power of the transmit signal. The magnitude of the amplification of the power depends on transmit power control information received from the transmit power control unit 209. Processes performed by the transmit power control unit 209 will be described later. The radio transmission unit 203 further performs up-conversion of a baseband signal into a carrier frequency. A signal output from the wireless transmit unit 203 is transmitted via the transmit antenna 204 to the base station apparatus 101.

A signal transmitted from the base station apparatus 101 is input to the radio reception unit 206 via the receive antenna 205. The radio reception unit 206 performs down-conversion of a carrier frequency into a baseband, Auto Gain Control (AGC), band limiting filtering, Analog to Digital (A/D) conversion, and other processes on the input signal and inputs a resultant signal to the control information extraction unit 207. The control information extraction unit 207 extracts control information from the input signal and inputs the extracted control information to the transmit signal generation unit 202, the band determination unit 208, and the transmit power control unit 209.

Next, the band determination unit 208 will be described. The band determination unit 208 determines on which band (frequency band) a signal is to be transmitted from the radio transmission unit 203. The control information required for the determination is, for example, the band on which control information is received by the radio reception unit 206 in a case of Time Division Duplex (TDD), or the band on which the control information is received by the radio reception unit 206 and the band on which the uplink band is associated with the downlink band of the control information in a case of Frequency Division Duplex (FDD). Alternatively, when the terminal apparatus 102 performs communication simultaneously using a plurality of bands (component carriers), the terminal apparatus 102 may perform signal transmission by using bands other than the band on which the control information is received or the associated uplink band. In LTE, logical indices are provided to a plurality of bands (component carriers) on which transmission/reception is possible, and control information designating a band to be used for transmission based on the index is referred to as a Carrier Indicator Field (CIF). Based on the control information such as the CIF designating a band to be used for the transmission, the band determination unit 208 may determine the band used by the terminal apparatus 102 for the uplink. Here, “determine” means to determine whether the frequency band used for uplink transmission is the licensed band or the unlicensed band. Here, information indicating whether the frequency band is the unlicensed band or the licensed band is hereinafter referred to as license information. The license information generated in the band determination unit 208 is input to the transmit power control unit 209.

The transmit power control unit 209 performs transmit power control based on the license information input from the band determination unit 208, the control information input from the control information extraction unit 207 and used for transmit power control, and an expression to perform the transmit power control. For example, the transmit power control of a channel (Physical uplink shared channel: PUSCH) to transmit uplink data information in the i-th subframe is expressed as follows.

$${P}_{PUSCH , c} ( i ) = min \{ \begin{matrix}{P}_{CMAX , c} ( i ) , \\ \begin{matrix}10 {log}_{10} ( {M}_{PUSCH , c} ( i ) ) + {P}_{O \_ PUSCH , c} ( j ) + \\ {α}_{c} ( j ) \cdot {PL}_{c} + {Δ}_{TF , c} ( i ) + {f}_{c} ( i )\end{matrix}\end{matrix} \} \qquad [ Math . 1 ]$$

Here, P_{CMAX,c}(i) is a value which represents allowable maximum transmit power in the i-th subframe of the c-th component carrier and which can be configured by the terminal apparatus 102 within a range designated by the base station apparatus 101. The lower part of the right side of the expression is transmit power required by the base station apparatus 101 (required transmit power). As shown by the expression, the terminal apparatus 102 performs transmission with a desired quality while suppressing the transmit power to less than or equal to the maximum transmit power, and therefore, the transmission is performed with a lower one of the allowable maximum transmit power and the required transmit power.

Note that calculation of the required transmit power requires M_{PUSCH,c}(i) which is the number of allocation resource blocks of the PUSCH in the i-th subframe, P_{O}_{_}_{PUSCH,c}(j) which is a parameter representing a target receive power, α_{c}(j) which is a parameter for performing fractional TPC, Δ_{TF,c}(i) which is determined by a selected MCS, f_{c}(i) which is a parameter for closed loop TPC referred to as a TPC command, and other parameters. These pieces of control information used for the transmit power control are input from the control information extraction unit 207. PL_{c} is a path loss value of the c-th component carrier, and is in general, a downlink path loss estimation value calculated by the terminal apparatus 102 from the transmit power of the base station 101 and the receive power of the terminal apparatus 102.

Here, expressions used in the transmit power control according to the present embodiment will be described. When the license information represents a licensed band, the transmit power control unit 209 performs the transmit power control by using Expression 1 used for conventional transmit power control. When the license information represents an unlicensed band, the transmit power control unit 209 performs the transmit power control by using an expression different from that used for the conventional transmit power control. This is because in the licensed band, the maximum transmit power is specified, but in the unlicensed band, transmit power may be limited by a method different from that in the licensed band, for example, by power per unit band, that is, a power spectral density. If the expression similar to that used for the conventional transmit power control is used in such a case to limit the transmit power, transmission may be performed with power greater than or equal to a specified value. Therefore, a case is considered in which the transmit power control unit 209 of the present embodiment performs the transmit power control based on, for example, the following expression.

$${P}_{PUSCH , c} ( i ) = min \{ \begin{matrix}{X}_{ULB} + 10 {log}_{10} ( {M}_{PUSCH , c} ( i ) \cdot {N}_{sc}^{RB} \cdot Δ f ) , \\ \begin{matrix}10 {log}_{10} ( {M}_{PUSCH , c} ( i ) ) + {P}_{O \_ PUSCH , c} ( j ) + \\ {α}_{c} ( j ) \cdot {PL}_{c} + {Δ}_{TF , c} ( i ) + {f}_{c} ( i )\end{matrix}\end{matrix} \} \qquad [ Math . 2 ]$$

Math. 2 makes a specification different from P_{CMAX,c} of Math. 1. Here, X_{ULB} of the upper part is a value configured when it is specified that the power spectral density has to be less than or equal to X_{ULB} [dBm/kHz] in the unlicensed band. The second term of the upper part includes M_{PUSCH,c}(i) which is the bandwidth of the resource allocation, N_{sc}^{RB} which is the number of subcarriers of the one resource block (RB), and Δf [kHz] which is the subcarrier interval. The whole of the second term represents a used bandwidth [kHz]. The whole of the upper part represents transmit power [dBm] allowable in the used bandwidth when the power spectral density is specified as X_{ULB}.

In this way, controlling the transmit power using an expression different from the conventionally used expression allows optimal power control even when the transmit power is limited by a different regulation. Note that the allowable maximum transmit power spectral density X_{ULB} or information about the X_{ULB} may be preliminary specified by the system, or may be reported to the terminal apparatus 102 from the base station apparatus 101, or the like as system information (for example, System Information Block, SIB). Moreover, a different value of the X_{ULB} or the information about the X_{ULB} may be configured for each frequency band, or each carrier component.

The unlicensed band may be limited by both the maximum transmit power of the terminal apparatus 102 and an average transmit power per unit frequency (i.e., power spectral density). In this case, for example, the transmit power is limited by the following expression.

$${P}_{PUSCH , c} ( i ) = min \{ \begin{matrix}{P}_{CMAX , c} ( i ) , \\ {X}_{ULB} + 10 {log}_{10} ( {M}_{PUSCH , c} ( i ) \cdot {N}_{sc}^{RB} \cdot Δ f ) , \\ \begin{matrix}10 {log}_{10} ( {M}_{PUSCH , c} ( i ) ) + {P}_{O \_ PUSCH , c} ( j ) + \\ {α}_{c} ( j ) \cdot {PL}_{c} + {Δ}_{TF , c} ( i ) + {f}_{c} ( i )\end{matrix}\end{matrix} \} \qquad [ Math . 3 ]$$

As shown by the above expression, when the unlicensed band is limited by both the maximum transmit power of the terminal apparatus 102 and the power spectral density, transmission is performed with the lowest one of the allowable maximum transmit power, the allowable maximum transmit power spectral density, and a desired transmit power. Whether the transmit power is controlled by using Expression 2 or Expression 3 in the unlicensed band may be predetermined, or may be transmitted as system information. The used expression may be changed based on control information reported by Radio Resource Control (RRC), or the like so as to further change the control method for each terminal apparatus, each base station apparatus, or each subframe.

The value of transmit power calculated by the transmit power control unit 209 is input to the radio transmission unit 203. The radio transmission unit 203 amplifies the input transmit power. The power may be amplified by only a power amplifier in the radio transmission unit 203, or by changing a digital signal before DA conversion, or by both adjusting the digital signal and an analog power amplifier.

As described above, when the way of specifying the transmit power differs between the licensed band and a frequency band (for example, unlicensed band) other than the licensed band, the expression of the transmit power control is changed to perform transmit power control. As a result, transmission can be performed with necessary minimum power without performing transmission with transmit power exceeding the specification.

Note that wireless LAN (Wi-Fi) such as IEEE802.11a, IEEE802.11b, IEEE802.11g, or IEEE802.11ac performs communication using an unlicensed band, but unlike W-CDMA and LTE, performs no transmit power control. That is, in the unlicensed band, transmit power control is not necessarily performed. Therefore, when the terminal apparatus 102 is assigned to transmission on a secondary cell (SCell) of the unlicensed band by the PDCCH (or EPDCCH) of a primary cell (PCell) of the licensed band, the transmit power control does not have to be performed. That is, depending on to which band (licensed band or unlicensed band) the uplink is assigned (i.e., depending on license information), the transmit power control unit 209 may configure whether or not the transmit power control is performed.

Moreover, the present embodiment has described a case where the transmit power spectral density is limited in the unlicensed band as a specification relating to transmit power other than the allowable maximum transmit power, but the present invention is not limited to this embodiment. For example, the allowable maximum transmit power is specified by 6.2.5 of 3GPP TS36.101, but in addition to this specification, unlicensed band-specific allowable maximum transmit power may be similarly specified in the unlicensed band. When the unlicensed band-specific allowable maximum transmit power is, for example, P_{CMAX,ULB}, the transmit power is limited by the P_{CMAX,ULB} in addition to the P_{CMAX} in the unlicensed band. Thus, the transmit power of the unlicensed band falls within the specified range of values while optimal transmit power control can be performed.

In the above case, two types of power, the maximum transmit power of the terminal apparatus 102 and the maximum transmit power according to the specification of the unlicensed band are defined, but the maximum transmit power P_{CMAX,c} of the terminal apparatus 102 may be differently limited between the licensed band and the unlicensed band to control the transmit power of the unlicensed band. For example, the terminal apparatus 102 controls the P_{CMAX,c} to be greater than or equal to P_{CMAX}_{_}_{L,c} and less than or equal to P_{CMAX}_{_}_{H,c}. Here, the specification (3GPP TS36.101) describes that the P_{CMAX}_{_}_{H,c} is a smaller one of P_{PowerClass} specified in the terminal apparatus 102 and P_{EMAX,c} reported by the RRC, but in the unlicensed band, one more variable may further be added, and the smallest value of the three values may be the P_{CMAX}_{_}_{H,c}. Alternatively, controlling P_{CMAX}_{_}_{L,c}, but not P_{CMAX}_{_}_{H,c}, may control the transmit power of the unlicensed band to fall within a range of specified values.

### Second Embodiment

The first embodiment has described a case where the transmit power control is applied to only the prescribed component carrier. This case assumes that communication is performed with only unlicensed band instantaneously, or that transmit power control is performed on the unlicensed band and the licensed band independently. However, the unlicensed band and the licensed band may be simultaneously used by the CA, and total transmit power may be controlled to be less than or equal to a specified value. Thus, the present embodiment describes a case where the transmit power control of the unlicensed band depends on the transmit power control of the licensed band when the CA is performed on the unlicensed band and the licensed band.

With reference to FIG. 3, the configuration of a terminal apparatus 102 of the present embodiment will be described. An information bit sequence generated by a data generation unit 301 is input to an S/P transformation unit 302, subjected to serial-parallel conversion, and input to a CC1 transmit signal generation unit 303-1 and a CC2 transmit signal generation unit 303-2. Here, in FIG. 3, the number of CCs is two, but the present invention is not limited to this embodiment and may include any number of CCs without limitation. Note that the CC1 transmit signal generation unit 303-1 and the CC2 transmit signal generation unit 303-2 each perform a process similar to that performed in the transmit signal generation unit 202 of FIG. 2. Transmit signals output from the CC1 transmit signal generation unit 303-1 and the CC2 transmit signal generation unit 303-2 are input to a CA radio transmission unit 304. A process performed by the CA radio transmission unit 304 is substantially the same as that performed by the radio transmission unit 203 of FIG. 2, but is different from that performed by the radio transmission unit 203 of FIG. 2 in that different transmit power control is performed on each CC, and then, a composition process is performed. Note that a band determination unit 309 is different from the band determination unit of FIG. 2 in that the band determination unit 309 determines the license information of each CC, inputs the license information to a transmit power control unit 310, and the transmit power control unit 310 calculates the transmit power of each CC.

When the CA is performed in a currently available LTE, the transmit power control unit 310 performs power control based on the following expression described in Non Patent Literature 1.

$${\sum }_{c} w ( i ) \cdot {\hat{P}}_{PUSCH , c} ( i ) \leq ( {\hat{P}}_{CMAX} ( i ) - {\hat{P}}_{PUCCH} ( i ) ) \qquad [ Math . 4 ]$$

Here, the right side shows that from a true value of allowable maximum transmit power (linear value), a true value of transmit power of Physical uplink control channel (PUCCH) is subtracted. The left side shows that a total value of true values of transmit power of component carriers is multiplexed by a weight w(i) commonly used by the component carriers to control transmit power of the entire PUSCH in the i-th subframe to be less than or equal to a value obtained by subtracting the transmit power of the PUCCH from the allowable maximum transmit power.

Here, a case where the CA of the unlicensed band and the licensed band is performed will be considered. First, a case where the licensed band is controlled in a manner similar to a conventional manner and the unlicensed band is controlled independently will be described. In such a case, the transmit power control unit 310 performs transmit power control based on, for example, the following expression.

$$\{ \begin{matrix}{\sum }_{c ∈ LB} w ( i ) \cdot {\hat{P}}_{PUSCH , c} ( i ) \leq ( {\hat{P}}_{CMAX} ( i ) - {\hat{P}}_{PUCCH} ( i ) ) \\ {\sum }_{c ∈ ULB} w ( i ) \cdot {\hat{P}}_{PUSCH , c} ( i ) \leq {\hat{P}}_{CMAX , ULB} ( i )\end{matrix} \qquad [ Math . 5 ]$$

Similarly to the conventional example, the expression of the upper part of Math. 5 shows that the total power of the PUSCH of the licensed band is controlled to be less than or equal to a value obtained by subtracting the transmit power of the PUCCH from the allowable maximum transmit power. In the unlicensed band, as shown by the expression of the lower part of Math. 5, a maximum transmit power is specified independently of the licensed band, and the total power of the PUSCH of the unlicensed band (ULB) after subjected to the CA is controlled to be less than or equal to the maximum transmit power of the unlicensed band. Here, the maximum transmit power of the unlicensed band in the right side of the expression in the lower part may be preliminarily specified by the system or may be reported as system information from the base station apparatus 101. Moreover, in Math. 5, it is assumed that a common weight w(i) is used both in the licensed band and in the unlicensed band, but the licensed band and the unlicensed band (or each band for which transmit power is specified) may be differently weighted. The terminal apparatus 102 is capable of transmitting the PUCCH in the unlicensed band. In this case, the transmit power control unit 310 may control the transmit power of the PUSCH in the unlicensed band to be less than or equal to a value obtained by subtracting the transmit power of the PUCCH from the allowable maximum transmit power.

In this way, controlling the transmit power of the licensed band and the transmit power of the transmit power of the unlicensed band based on Math. 5 enables to perform control similar to conventional control on the licensed band and to perform transmit power control on the unlicensed band independently of the status of use of the licensed band.

Next, a case where the transmit power of the unlicensed band is specified also in consideration of the transmit power of the licensed band will be described. Here, the transmission performance of transmission in the unlicensed band may degrade due to unexpected interference, or other causes from a circuit, or the like of an electronic device (for example, a microwave, or the like). Therefore, a priority in terms of transmission is preferably assigned to the licensed band over the unlicensed band. In this case, the licensed band is subjected to transmit power control similar to Math. 4, and the unlicensed band is subjected to transmit power control based on the following expression.

$${\sum }_{c ∈ ULB} {w}_{ULB} ( i ) \cdot {\hat{P}}_{PUSCH , c} ( i ) \leq ( {\hat{P}}_{CMAX} ( i ) - {\hat{P}}_{PUCCH} ( i ) - {\sum }_{c ∈ LB} {w}_{LB} ( i ) \cdot {\hat{P}}_{PUSCH , c} ( i ) ) \qquad [ Math . 6 ]$$

Here, the right side of the Math. 6 is a value obtained by subtracting the transmit power of the PUCCH and the transmit power of the PUSCH of the licensed band from the allowable maximum transmit power. The transmit power of the PUSCH in the unlicensed band is controlled by weighting the transmit power of the PUSCH of each component carrier in the unlicensed band with w_{ULB}(i) to control a total value to be less than or equal to the value of the right side. As a result, a priority is assigned to the transmission of the PUSCH and the PUCCH in the licensed band, while the PUSCH may be transmitted in the unlicensed band within a specified range. Note that when the w_{ULB} is configured to satisfy the relationship w_{LB}(i)≧w_{ULB}(i), power can be distributed with a priority assigned to the licensed band. In a case where w_{LB}(i)≠1, that is, transmission is performed in the licensed band with power less than the required transmit power, the w_{ULB} is configured such that w_{ULB}(i)=0, which can also achieve that the transmission of the PUSCH in the unlicensed band is not performed. However, in this case, the transmit power is not set to 0, but allocation of wireless resources to the terminal apparatus 102 itself may be omitted.

In the above-described case, the unlicensed band is more susceptible to interference from other systems than the licensed band, and therefore, preferentially allocating power to the licensed band has been described, but power may be preferentially allocated to the unlicensed band exceptionally depending on types of signals to be transmitted on the unlicensed band. For example, in a case where control information is transmitted on a component carrier of the unlicensed band and data information is transmitted on a component carrier of the licensed band, more power may be allocated to the unlicensed band. Here, the control information transmitted on the component carrier in the unlicensed band may be transmitted on the PUCCH or the PUSCH. Moreover, the control information includes a plurality of types of control information, and the types of control information to be transmitted may be limited. For example, when ACK/NACK is transmitted in the unlicensed band and only the information data is transmitted in the licensed band, power is preferentially allocated to the unlicensed band, whereas when Channel state information (CSI) is transmitted in the unlicensed band, power is preferentially allocated to the licensed band. When a Sounding reference signal (SRS) is transmitted in the licensed band, power may be preferentially allocated to the unlicensed band.

The present embodiment has described the transmit power control in a case where the unlicensed band and the licensed band are used simultaneously, i.e., the CA is performed. When electric power control is independently applied to the licensed band and the unlicensed band, transmit power control is applied based on the maximum transmit power of the unlicensed band and when electric power control is applied to the licensed band and the unlicensed band dependently on each other, a priority is assigned to the transmit power of the PUCCH and the PUSCH of the licensed band, and transmit power control of the unlicensed band is performed to an extent possible with the remaining power. As described above, the method for controlling the transmit power is changed based on a method for specifying the transmit power of the unlicensed band, which enables transmission with optimal transmit power in conformity with the specification of the transmit power.

### Third Embodiment

Although description is omitted in the first and second embodiments, the terminal apparatus 102 notifies the base station apparatus 101 of a value called power headroom (PH) in LTE. The PH is a value obtained by subtracting the required transmit power from the allowable maximum transmit power P_{MAX,c}. A positive PH shows that the terminal apparatus 102 has surplus transmit power. A negative PH shows that transmission cannot be performed with transmit power desired by the base station apparatus 101 and that the terminal apparatus 102 is forced to perform transmission with maximum transmit power.

In the unlicensed band, as described in the above embodiments, the transmit power may be limited by a regulation other than the P_{CMAX,c}. In this case, the transmit power may be limited by specifications other than the P_{CMAX,c} even when a value obtained by subtracting the required transmit power from the P_{CMAX,c} is positive. In this case, the base station apparatus 101 is notified that the PH is positive, and therefore, the base station apparatus 101 determines that the terminal apparatus 102 has surplus transmit power and may require a further increase in transmit power by transmit power control of the closed loop. On the other hand, the transmit power of the terminal apparatus 102 is limited by the regulation other than the P_{CMAX,c}, which may results in a situation in which the transmit power cannot be increased. That is, the base station apparatus 101 cannot grasp the surplus of the transmit power of the terminal apparatus 102 although the terminal apparatus 102 notifies the base station apparatus 101 of the PH.

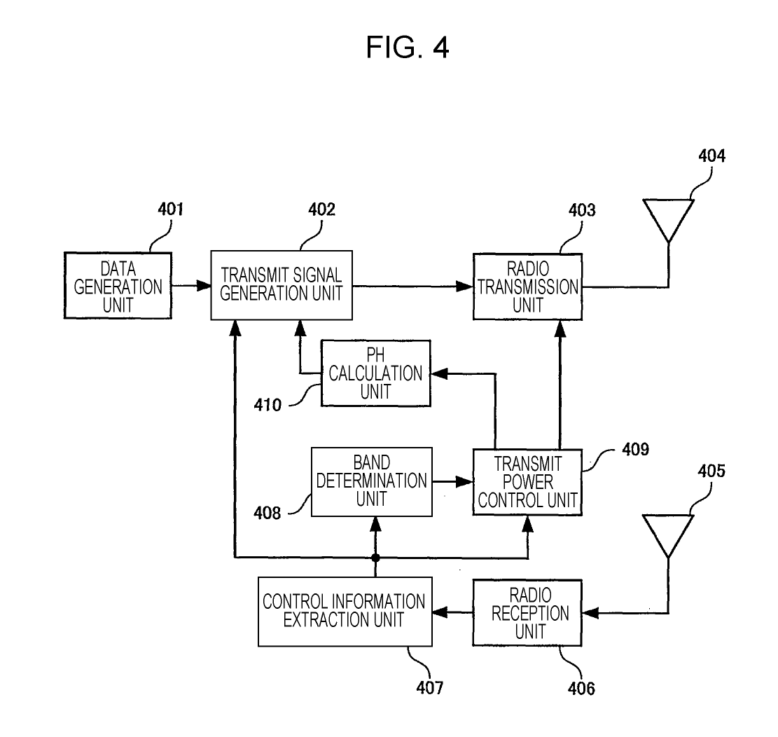

Therefore, with reference to FIG. 4, the present embodiment will describe a method for suitably calculating the PH even when the transmit power of the unlicensed band is specified by the regulation other than the P_{CMAX,c}.

A transmit power value calculated by a power control unit 409 and required by the base station apparatus 101 is input to a PH calculation unit 410. A method for calculating the PH of the conventional LTE is described in Non Patent Literature 1. Here, the LTE Rel-10 or later versions allows simultaneous transmission of the PUCCH and the PUSCH, and therefore, there are two PHs, PH_{type1,c}(i) and PH_{type,2,c}(i)as the PHs of the c-th component carrier. Only the PH_{type1,c}(i) will be described. The PH_{type2,c}(i) may be calculated in a similar manner as the PH_{type1,c}(i).

The calculation expression of the PH_{type1,c}(i) by the PH calculation unit 410 of the present embodiment is as follows.

PH_{type1,c}(i)=min{P_{CMAX,c}(i), X_{UBL}+10 log₁₀(M_{PUSCH,c}(i)·N_{sc}^{RB}·Δf)}−{10 log₁₀(M_{PUSCH,c}(i))+P_{O}_{_}_{PUSCH,c}(j)+α_{c}(j)·PL_{c}+Δ_{TF}_{_{c}}(i)+f_{c}(i)} [Math. 7]

As illustrated in the above expression, in the conventional licensed band, a value obtained by subtracting the required transmit power from the P_{CMAX,c} is the PH, whereas in the present embodiment, in the component carrier of the unlicensed band, a lower one of the P_{CMAX,c} and a specified value other than the P_{CMAX,c} is selected, and a value obtained by subtracting the required transmit power from the selected value is the PH. The PH is specified as described above, and therefore, the base station apparatus 101 may be notified of a PH according to the power limitation of the terminal apparatus 102.

Here, since the PH is an important value determining the throughput of the entire cellular system, transmission of the PH to the base station apparatus 101 is preferably ensured. Therefore, the PH is transmitted on the PUSCH of a PCell (or SCell) of the licensed band, but not on the unlicensed band which is susceptible to the power limitation. In this way, the possibility of reception of the PH by the base station apparatus 101 can be increased.

When the PH is not defined as shown by Math. 7, but a value obtained by subtracting the required transmit power from the P_{CMAX,c} in a manner similar to the conventional licensed band is defined as the PH, the base station apparatus 101 receives the PH but when the terminal apparatus 102 is limited by the transmit power regulation of the unlicensed band, the PH performs no function and may result in useless information. Therefore, the PH of the licensed band is transmitted, whereas the PH of the unlicensed band is not transmitted, thereby reducing uplink control information.

Programs which run on the base station apparatus and terminal devices of the present invention are programs for controlling a CPU, and the like (programs for operating a computer) to realize the functions of the embodiments relating to the present invention. Information processed in these apparatuses is temporarily accumulated in a RAM during processing, is then stored in various ROMs or HDDs, and is accordingly subjected to read, modify, and/or write operations by the CPU. The recording medium for storing the programs may be any of a semiconductor medium (for example, ROM, nonvolatile memory card, etc.), an optical recording medium (for example, DVD, MO, MD, CD, and BD), a magnetic recording medium (for example, magnetic tape, flexible disk, etc.), or the like. The functions of the embodiments are realized by executing loaded programs, but the functions of the embodiments may also be realized by performing processes based on instructions of the programs in combination with an operating system, other application programs, and the like.

When the programs are released to the market, the programs can be stored on portable recording media or can be transferred to server computers connected via a network such as the Internet. In this case, memory of server computers is included in the present invention. Some or all of the functional units of the terminal devices and the base station apparatus of the embodiments may typically be realized as an LSI, which is an integrated circuit. The functional blocks of the receiver may be individually made into chips, or some or all of the functional blocks may be integrated into a chip. When functional blocks are made into an integrated circuit, an integrated circuit controlling unit for controlling the functional blocks is added.

A method for fabricating an integrated circuit is not limited to LSI but may be realized by using a dedicated circuit or a general purpose processor. When progress in semiconductor technology provides an integrated circuit technology replacing LSI, an integrated circuit formed by the provided integrated circuit technology can be used.

The invention of the present application is not limited to the embodiments described above. The terminal device of the invention of the present application is not limited to application to the mobile station apparatus. The terminal device is of course applicable to stationary or immovable electronic devices, for example, AV equipment, kitchen appliances, cleaning/washing devices, air conditioning apparatuses, office equipment, vending machines, and other living appliances installed indoors or outdoors.

While preferred embodiments of the invention have been described in detail with reference to the drawings, specific configurations are not limited to these embodiments, and designs and other modifications which do not depart from the spirit of the invention are included within the scope of the claims.

### INDUSTRIAL APPLICABILITY

The present invention is suitable for use in terminal apparatuses.

This PCT application claims the priority benefit of Japanese Patent Application No. 2014-125991 filed with the Japan Patent Office on Jun. 19, 2014, the content of which is incorporated herein by reference in its entirety.

### REFERENCE SIGNS LIST

101 BASE STATION APPARATUS

102 TERMINAL APPARATUS

201 DATA GENERATION UNIT

202 TRANSMIT SIGNAL GENERATION UNIT

203 RADIO TRANSMISSION UNIT

204 TRANSMIT ANTENNA

205 RECEIVE ANTENNA

206 RADIO RECEPTION UNIT

207 CONTROL INFORMATION EXTRACTION UNIT

208 BAND DETERMINATION UNIT

209 TRANSMIT POWER CONTROL UNIT

301 DATA GENERATION UNIT

302 S/P TRANSFORMATION UNIT

303-1 CC1 TRANSMIT SIGNAL GENERATION UNIT

303-2 CC2 TRANSMIT SIGNAL GENERATION UNIT

304 CA RADIO TRANSMISSION UNIT

305 TRANSMIT ANTENNA

306 RECEIVE ANTENNA

307 RADIO RECEPTION UNIT

308 CONTROL INFORMATION EXTRACTION UNIT

309 BAND DETERMINATION UNIT

310 TRANSMIT POWER CONTROL UNIT

401 DATA GENERATION UNIT

402 TRANSMIT SIGNAL GENERATION UNIT

403 RADIO TRANSMISSION UNIT

404 TRANSMIT ANTENNA

405 RECEIVE ANTENNA

406 RADIO RECEPTION UNIT

407 CONTROL INFORMATION EXTRACTION UNIT

408 BAND DETERMINATION UNIT

409 TRANSMIT POWER CONTROL UNIT

410 PH CALCULATION UNIT

1. A terminal apparatus, comprising:
carrier aggregation radio transmission circuitry configured to simultaneously transmit a plurality of component carriers; and
transmit power control circuitry configured to control transmit power of each of the plurality of component carriers, wherein
the transmit power control circuitry is configured to
calculate a transmit power of a dedicatedly usable first component carrier among the plurality of component carriers in consideration of the transmit power of the first component carrier, and
calculate a transmit power of a second component carrier other than the dedicatedly usable first component carrier in consideration of the transmit power of the first component carrier.

2. The terminal apparatus of claim 1, wherein
the transmit power control circuitry is configured to control the transmit power of the second component carrier to be less than or equal to a value obtained by subtracting the transmit power of the first component carrier from allowable maximum transmit power of the terminal apparatus.

3. The terminal apparatus of claim 1, wherein
the transmit power control circuitry is configured to calculate the transmit power of the second component carrier in consideration of a power spectral density per frequency.

4. A terminal apparatus, comprising:
carrier aggregation radio transmission circuitry configured to simultaneously transmit a plurality of component carriers including at least a dedicatedly usable first component carrier and a second component carrier other than the dedicatedly usable first component carrier; and
transmit power control circuitry configured to control transmit power of each of the plurality of component carriers, wherein
the transmit power control unit circuitry is configured to
calculate a transmit power of the second component carrier in consideration of the transmit power of the second component carrier in a case of transmitting a control signal on the second component carrier, and
calculate a transmit power of the first component carrier in consideration of the transmit power of the second component carrier.
